(19) United States
(12) Patent Application Publication
(10) Pub. No.: US 2021/0279227 A1
(43) Pub. Date: Sep. 9, 2021

(54) SYSTEM AND METHODS FOR CAPTURING AND STORING METADATA FROM ACCESS LOGS AND STORAGE SYSTEMS AND IMPROVING STORAGE EFFICIENCY OF DATA AND METHOD THEREFOR

(71) Applicant: KOMPRISE INC., Cambell, CA (US)

(72) Inventors: MICHAEL PEERCY, CAMPBELL, CA (US); KUMAR GOSWAMI, CAMPBELL, CA (US); KRISHNA SUBRAMANIAN, CAMPBELL, CA (US); MOHIT DHAWAN, CAMPBELL, CA (US)

(21) Appl. No.: 17/190,088

(22) Filed: Mar. 2, 2021

Related U.S. Application Data
(60) Provisional application No. 62/984,512, filed on Mar. 3, 2020.

(51) Int. Cl. G06F 16/23; G06F 16/2457; G06F 16/248; G06F 16/28

(52) U.S. Cl. CPC G06F 16/2358; G06F 16/2322; G06F 16/289; G06F 16/248; G06F 16/24573

(57) ABSTRACT

An electronic file storage system has a processor. A memory is coupled to the processor, the memory storing program instructions that when executed by the processor, causes the processor to: read an access log; and infer access time, modify time, create time, delete time, other metadata from the access log unavailable on the access log, wherein access time, modify time, create time, delete time and other metadata about an object is inferred from a timestamp and record of an operation on an object recorded on the access log.

### RELATED APPLICATIONS

This patent application is related to U.S. Provisional Application No. 62/984,512 filed Mar. 3, 2020, entitled “SYSTEM AND METHODS FOR CAPTURING AND STORING METADATA FROM ACCESS LOGS AND STORAGE SYSTEMS AND IMPROVING STORAGE EFFICIENCY OF DATA” in the name of the same inventors, and which is incorporated herein by reference in its entirety. The present patent application claims the benefit under 35 U.S.C § 119(e).

### TECHNICAL FIELD

The present application generally relates to metadata, and more specifically, to a system and method for the useful analysis and operations on the metadata and data of objects in object storage systems to ensure that hot objects remain in the higher cost, high performance tiers while cold objects are transferred to lower cost, low performance storage tiers.

### BACKGROUND

Modern information technology (IT) data management may involve organizing, transferring, and storing a vast amount of ever-increasing accumulation of data across multiple data storages in various locations. A greatly growing area of storage is object storage, both on-premises and in the cloud. However, for efficiency and speed at scale, object storage is designed to have each object written once. Hence the access time of an object is not recorded with the object, as is common on network file storage devices, as that would induce a write of object metadata every time there is a read.

For auditing reasons, many object storage systems maintain a written log that tracks all accesses of any type, be they reads, writes, deletions, modifications, etc. The HTTP access record may be stored in the access log with the HTTP method, the object location, and any useful parameters and headers. The access log may consist of an object store HTTP method, e.g., GET, PUT, DELETE, and the parameters of the method. This log may include the time that each access event occurred.

Knowing the last access time and the historical pattern of accesses can be used to identify those objects that are least likely to be accessed in the future, also known as cold objects, for transfer to lower cost storage tiers. Lower cost storage tiers have slower access times and, in a public cloud, can have higher costs per access. As a result, it is expedient in terms of cost and performance to ensure that hot objects, those that have been accessed in the near past and have a high probability of being re-accessed in the near future, remain in the higher cost, high performance tiers while cold objects are transferred to lower cost, low performance storage tiers. This approach will reduce costs while maintaining high performance for the hot objects.

Therefore, it would be desirable to provide a system and method that accomplishes the above. The system and method would capture and store metadata from access logs and storage systems in order to improve storage efficiency of data. The system and method would ensure that hot objects remain in higher cost, high performance tiers while cold objects are transferred to lower cost, lower performance storage tiers in order to reduce costs while maintaining high performance for the hot objects.

### SUMMARY

In accordance with one embodiment, an electronic file storage system is disclosed. The electronic file storage system comprising has a processor. A memory is coupled to the processor. The memory stores program instructions that when executed by the processor, causes the processor to: read an access log; and infer access time, modify time, create time, delete time, other metadata from the access log unavailable on the access log, wherein access time, modify time, create time, delete time and other metadata is inferred from a timestamp of an object recorded on the access log.

In accordance with one embodiment, an electronic file storage system is disclosed. The electronic file storage system comprising has a processor. A memory is coupled to the processor. The memory stores program instructions that when executed by the processor, causes the processor to: parse an access log; infer access time, modify time, create time, delete time, other metadata from the access log unavailable on the access log, wherein access time, modify time, create time, delete time and other metadata is inferred from a timestamp of an object recorded on the access log, wherein time is inferred from the timestamp of the object record, wherein access time is inferred from logged reads, create time and modify times are inferred from logged writes, and other times are inferred from other logged operations metadata or other data update times; capture a series of access, create, modify, and delete times for the object to store a history of the object; determine the probability of the object being accessed or modified using recency of access and historical pattern of access; and label the object as one of a “hot” object or a “cold” object based on the probability.

### BRIEF DESCRIPTION OF THE DRAWINGS

The present application is further detailed with respect to the following drawings. These figures are not intended to limit the scope of the present application but rather illustrate certain attributes thereof. The same reference numbers will be used throughout the drawings to refer to the same or like parts.

FIG. 1 is a diagram of an exemplary electronic metadata analysis and storage system according to one aspect of the present application;

FIG. 2 is a simplified block diagram of an exemplary embodiment of a computing device/server depicted in FIG. 1 in accordance with one aspect of the present application;

FIG. 3 is an exemplary embodiment of an access log used in the system of FIG. 1 in accordance with an embodiment of the present invention;

FIG. 4 is an exemplary embodiment of a database used in the system of FIG. 1 in accordance with an embodiment of the present invention; and

FIG. 5 is an exemplary embodiment of a chart showing transitions based on access time patterns using the system of FIG. 1 in accordance with an embodiment of the present invention.

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

Specific embodiments of the invention may now be described in detail with reference to the accompanying figures. Like elements in the various figures may be denoted by like reference numerals for consistency.

In the following detailed description of embodiments of the invention, numerous specific details may be set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The detailed description may be presented largely in terms of description of shapes, configurations, and/or other symbolic representations that directly or indirectly resemble one or more novel electronic metadata analysis and storage systems and methods of operating such novel systems. These descriptions and representations may be the means used by those experienced or skilled in the art to most effectively convey the substance of their work to others skilled in the art.

Reference herein to “one embodiment” or “an embodiment” may mean that a particular feature, structure, or characteristic described in connection with the embodiment can be included in at least one embodiment of the invention. The appearances of the phrase “in one embodiment” in various places in the specification may not necessarily be all referring to the same embodiment. Furthermore, separate or alternative embodiments may not be necessarily mutually exclusive of other embodiments. Moreover, the order of blocks in process flowcharts or diagrams representing one or more embodiments of the invention do not inherently indicate any particular order nor imply any limitations in the invention.

Moreover, for the purpose of describing the invention, an “electronic system,” a “computing device,” and/or a “main computing device” may each be defined as electronic-circuit hardware device, such as a computer system, a computer server, a data storage unit, or another electronic-circuit hardware unit controlled, managed, and maintained by an analysis module, which is executed in a CPU and a memory unit of the electronic-circuit hardware device for the electronic file migration management.

In addition, for the purpose of describing the invention, a term “computer server” may be defined as a physical computer system, another hardware device, a software and/or hardware module executed in an electronic device, or a combination thereof. For example, in context of an embodiment of the invention, a “computer server” may be dedicated to executing one or more computer programs for creating, managing, and maintaining a robust and efficient metadata analysis and storage system. In a preferred embodiment of the invention, on-premises data storage and cloud data storage may be connected to or incorporated in one or more computer servers for the metadata analysis and storage system creation, management, and maintenance. Furthermore, in one embodiment of the invention, a computer server may be connected to one or more data networks, such as a local area network (LAN), a wide area network (WAN), a cellular network, and the Internet.

In accordance with one embodiment of the invention, an electronic metadata analysis and storage system copies “qualifying” files between different tiers of a file system or object store. Without loss of generality, the terms for files and objects can be considered interchangeable, and the terms for file systems and object stores can be considered interchangeable.

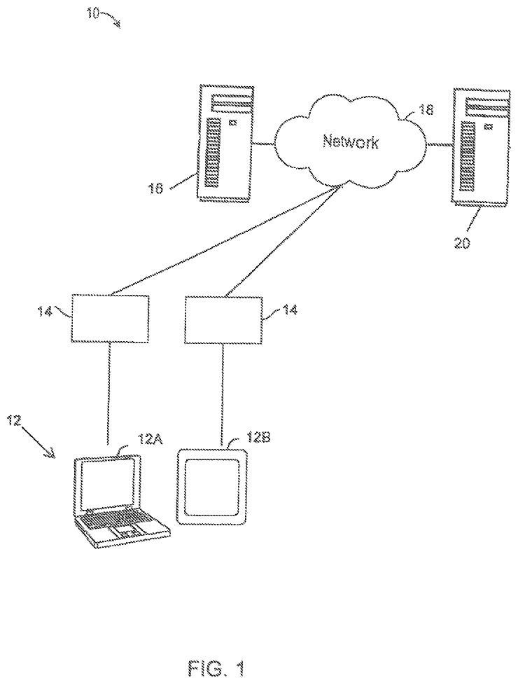

Referring to FIG. 1, a metadata analysis and storage system 10 (hereinafter system 10) may be seen. The components of the system 10 may be coupled through wired or wireless connections.

The system 10 may have one or more computing devices 12. The computing devices 12 may be a client computer system such as a desktop computer, handheld or laptop device, tablet, mobile phone device, server computer system, multiprocessor system, microprocessor-based system, network PCs, and distributed cloud computing environments that include any of the above systems or devices, and the like. The computing device 12 may be described in the general context of computer system executable instructions, such as program modules, being executed by a computer system as may be described below. In the embodiment shown in FIG. 1, the computing device 18 may be seen as a desktop/laptop computing system 12A and a tablet device 12B. However, this should not be seen in a limiting manner as any computing device 12 described above may be used.

The computing devices 12 may be loaded with an operating system 14. The operating system 14 of the computing device 12 may manage hardware and software resources of the computing device 12 and provide common services for computer programs running on the computing device 1.

The computing devices 12 may be coupled to a computer server 16 (hereinafter server 16). The server 16 may be used to store data files, programs and the like for use by the computing devices 12. The computing devices 12 may be connected to the server 16 through a network 18. The network 18 may be a local area network (LAN), a general wide area network (WAN), wireless local area network (WLAN) and/or a public network. In accordance with one embodiment, the computing devices 12 may be connected to the server 16 through a network 18 which may be a LAN through wired or wireless connections.

The system may have one or more servers 20. The servers 20 may be coupled to the server 16 and/or the computing devices 12 through the network 18. The network 18 may be a local area network (LAN), a general wide area network (WAN), wireless local area network (WLAN) and/or a public network. In accordance with one embodiment, the server 16 may be connected to the servers 20 through the network 18 which may be a WAN through wired or wireless connections.

The servers 20 may be used for analysis and storage of data. The server 20 may be any data storage devices/system. In accordance with one embodiment, the server 20 may be cloud data storage. Cloud data storage is a model of data storage in which the digital data is stored in logical pools, the physical storage may span multiple servers (and often locations), and the physical environment is typically owned and managed by a third-party hosting company. However, as defined above, cloud data storage may be any type of data storage device/system.

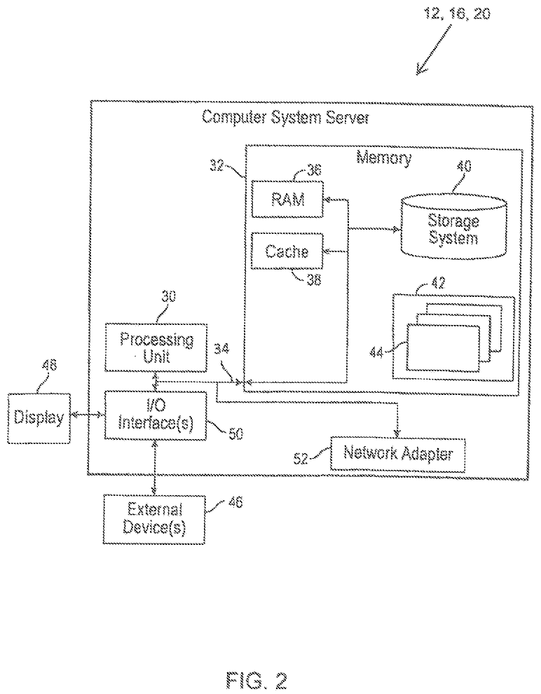

Referring now to FIG. 2, the computing devices 12 and/or servers 16, 20 may be described in more detail in terms of the machine elements that provide functionality to the systems and methods disclosed herein. The components of the computing devices 12 and/or servers 16, 20 may include, but are not limited to, one or more processors or processing units 30, a system memory 32, and a system bus 34 that couples various system components including the system memory 32 to the processor 30. The computing devices 12 and/or servers 16, 20 may typically include a variety of computer system readable media. Such media may be chosen from any available media, including non-transitory, volatile and non-volatile media, removable and non-removable media. The system memory 32 could include one or more personal computing system readable media in the form of volatile memory, such as a random-access memory (RAM) 36 and/or a cache memory 38. By way of example only, a storage system 40 may be provided for reading from and writing to a non-removable, non-volatile magnetic media device typically called a “hard drive”.

The system memory 32 may include at least one program product/utility 42 having a set (e.g., at least one) of program modules 44 that may be configured to carry out the functions of embodiments of the invention. The program modules 44 may include, but is not limited to, an operating system, one or more application programs, other program modules, and program data. Each of the operating systems, one or more application programs, other program modules, and program data or some combination thereof, may include an implementation of a networking environment. The program modules 44 generally carry out the functions and/or methodologies of embodiments of the invention as described herein.

The computing device 12 and/or servers 16, 20 may communicate with one or more external devices 46 such as a keyboard, a pointing device, a display 48, or any similar devices (e.g., network card, modern, etc.). The display 48 may be a Light Emitting Diode (LED) display, Liquid Crystal Display (LCD) display, Cathode Ray Tube (CRT) display and similar display devices. The external devices 46 may enable the computing devices 12 and/or servers 16, 20 to communicate with other devices. Such communication may occur via Input/Output (I/O) interfaces 50. Alternatively, the computing devices and/or servers 18, 20 may communicate with one or more networks 18 such as a local area network (LAN), a general wide area network (WAN), and/or a public network via a network adapter 52. As depicted, the network adapter 52 may communicate with the other components of the computing device 18 via the bus 34.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, microcode, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Any combination of one or more computer readable media (for example, storage system 40) may be utilized. In the context of this disclosure, a computer readable storage medium may be any tangible or non-transitory medium that can contain, or store a program (for example, the program product 42) for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing.

Presently, object stores and some other storage systems do not maintain access times of objects and files. Yet access times may be very important to decide what data is important for users. Data which users access frequently or recently is more likely to be accessed in the near future and should therefore reside on higher performance storage. Since higher performance storage may be more expensive than lower performance storage, data that users access less frequently or less recently can reside on less expensive storage. If the storage system does not provide the access times on the files to determine which files are recently accessed and which files are not, then the files cannot be placed to optimize cost against performance. However, object stores or other storage systems that do not maintain access times often do maintain access logs holding every read, write, update, and delete of an object or file in the system.

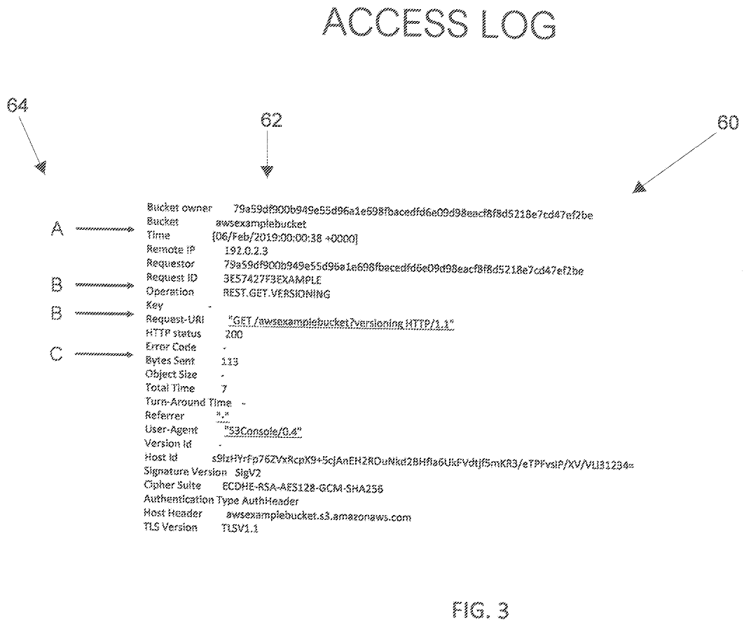

The system 10 may be configured to ingest access logs and infer access time, create time, modify time, delete time, and any other useful attributes of the file. Referring to FIG. 3, an access log 60 may be seen. The access log 60 may be from one of the computing devices 12 and/or the servers 16/20. The access log 60 may list a plurality of objects/files 62. Each of the object 62 may have an associated field 64. The field 64 may be used to inform fields in a database stored within the server 16/20. In accordance with one embodiment, the field labeled A may represents the time of the record, which may apply as an access time, modify time, update time, or delete time depending on the operation recorded in the record. The field labeled B may represent the operation being performed, be it read, write, update, delete, or metadata read. The field labeled C may represent the size of the object read or written, allowing the system 10 to record the size with the object 62 in the database.

In accordance with one embodiment of the present invention, the system 10 parses access logs for files and infers metadata for each file from the access log that is not available on the file itself. Time may be inferred from the timestamp of the record in the audit log. In particular, this embodiment infers from logged reads the access time, from logged writes the create or modify time, and from other logged operations metadata or other data update times.

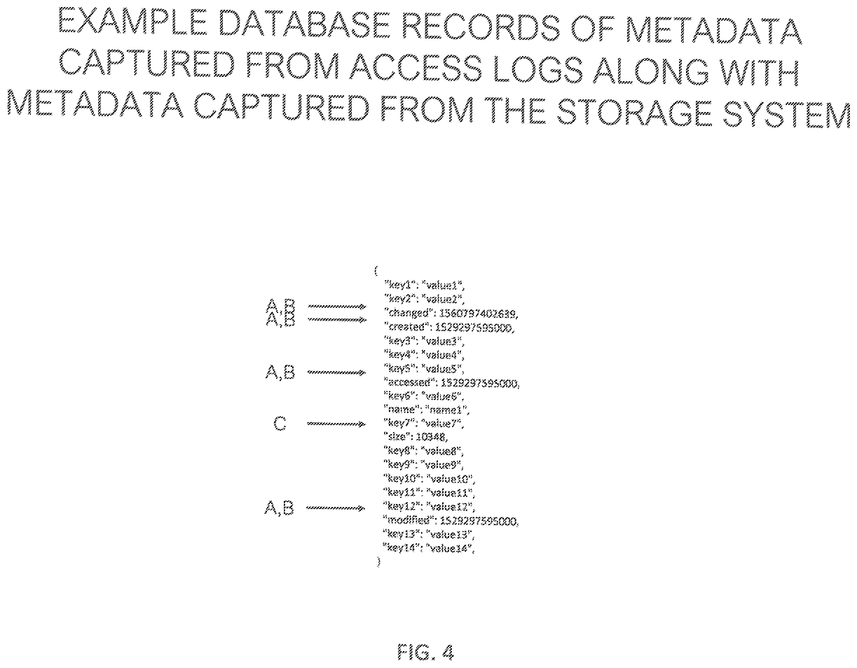

The system 10 may be configured to store the access time, modify time, create time, delete time, and other useful metadata of an object captured from access logs in a separate database of object metadata that can be queried by separate computer systems 12. Referring to FIG. 4, an example database record 70 may be seen. The database record 70 may be captured from access logs from a separate database of object metadata that can be queried by separate computer systems 12. The database record 70 may indicate metadata captured from access logs in a typical object store labeled as A, B, and C where the labels may be the same as in FIG. 3. The accessed, modified, created, and changed fields labeled A and B may be derived from access log record fields labeled A and B in FIG. 3 that may set out operation and time of the operation. The field labeled C may be the size as derived from the access log field labeled C in FIG. 3.

This aspect of the present invention recognizes the location of the object or file in the system 10 along with the times of access, create, modify, delete, and metadata update determined from the access log parsing and records these in a separate database for use by other aspects of the present invention.

Another aspect of the present invention enumerates all the objects in an object store, captures the metadata of those objects, and stores that metadata in a separate database of object metadata that can be queried by separate computer systems. As may be seen in FIG. 4, an example database record, indicating metadata captured from the metadata of an object in a typical object store may be shown. Of the labeled fields in FIG. 4, the only ones that can be derived from a metadata query of a typical object store may be the modified field labeled as A and B and the size field labeled as C. This aspect of the present invention traverses all objects in the object store, captures the metadata stored by the object store for each object, and records it in a separate database in the server 16 for use by other aspects of the present invention.

Another aspect of the present invention ingests records from the access logs, determines the object metadata from those records, captures the metadata of the object itself directly from the object store, and combines those two sources of metadata to produce a new record of the object metadata stored in the separate database. Referring to FIG. 4, an example database record, indicating metadata captured from the access log added to the metadata from the object store may be seen. The accessed, created, and changed fields labeled A and B may be derived from the access log shown in FIG. 3. The modified field labeled A and B in FIG. 4 and the size field labeled C can be derived from either access log or from object store metadata.

This aspect of the present invention recognizes the location of the object or file in the system 10 along with the times of access, create, modify, delete, and metadata update determined from the access log parsing. It may then make a direct request for the object metadata from the object store of the newly parsed object and record the metadata determined from parsing the access log along with the metadata captured from the object store itself for each object, and records it in a separate database for use by other aspects of the present invention.

Another aspect of the present invention uses the records from the object store access logs to capture a series of access, create, modify, and delete times for the object to store the history of the object in a separate database. Depending on the complexity of the embodiment, this series of, without loss of generality, access times can be stored in a separate table in the database or can be stored in a number of counters in the record for the object in the database that record how many accesses occurred in some past or ongoing time period.

Another aspect of the present invention uses the series of access and modify times of the objects to infer the probability that the objects will be accessed or modified in the future and stores this probability data of the object in a separate database. This aspect of an embodiment of the present invention uses both recency of access and historical pattern of access to determine the probability of access in the future. With regard to recency of access, objects and files are accessed frequently when they are being used frequently, so more recent accesses indicate a higher probability that the object will be accessed in the near future. With regard to the pattern of access, an object that is accessed in a regular pattern of one or more accesses in a predetermined short time frame followed by no accesses for a predetermined longer time frame, but whom the predetermined longer time frame is always the same length of time or falls at the same place on a calendar, e.g., weekly, monthly, quarterly, or annually, indicates a lower probability of access between the repeating historical times of access and a higher probability as the historical times of access will repeat again.

Another aspect of an embodiment of the present invention may use the last access time and probability of access information to identify “hot” and “cold” objects. Hot objects may be those with:
(a) * a recent access
(b) * a high probability of future access
(c) * or a combination of the two.

Cold objects may be those:
(a) * that have not been accessed in the near past (e.g., not accessed in a week, month, year, etc.)
(b) * with a low probability of future access
(c) * or a combination of the two.

These determinations of hot and cold may be stored in a separate database for quick recall of this information over large numbers of objects or files.

Another aspect of the present invention allows an administrator to specify a policy declaring what is hot or cold data and where such data should reside and acts on that policy to transition the data into the correct storage tier. This aspect of an embodiment of the present invention may consists of: (a) obtaining a policy from the administrator specifying a policy consisting of a definition of what is considered to be a “hot” object and a “cold” object and the storage tier to which they should be stored; (b) continually and periodically computing the objects' identities (whether hot or cold) and transferring the objects based on whether they are hot or cold to their respective storage tiers as specified by the policy; and (c) reverting cold objects that have been determined to be hot to their proper storage tiers as specified by the policy.

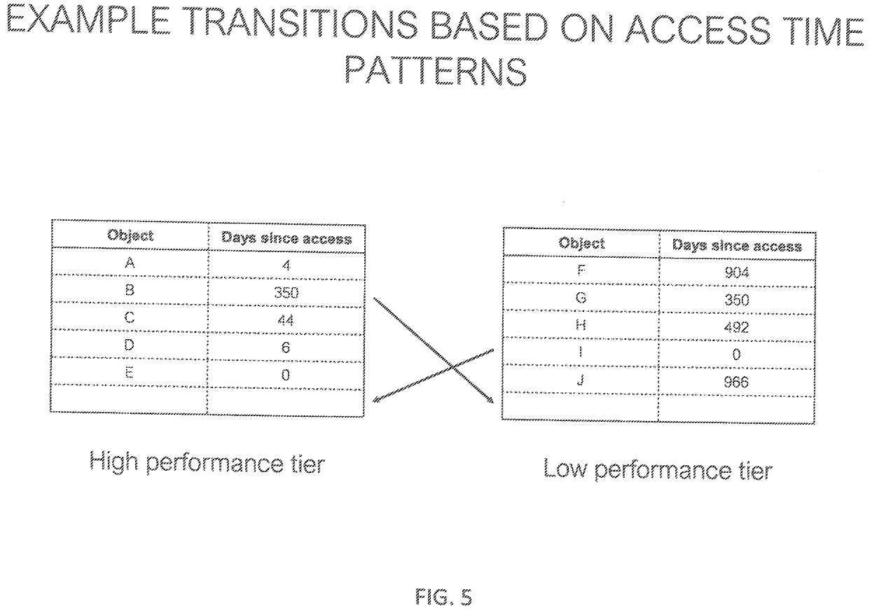

Referring to FIG. 5, two tiers of storage of objects with their respective days since last access along with two example transitions of data may be seen. Object B on the higher performance tier has, by not being accessed over an extended time, become cold and therefore qualifies for being transferred to the lower performance tier. Object I on the lower performance tier has become hot due to being accessed recently and determined to be likely to be accessed again and therefore qualifies for being transferred to the higher performance tier. The next time that the policy is evaluated object B will be transitioned from the higher performance tier to the lower performance tier following the left to right arrow, and object I will be transitioned from the lower performance tier to the higher performance tier following the right to left arrow.

The foregoing description is illustrative of particular embodiments of the application, but is not meant to be a limitation upon the practice thereof. The following claims, including all equivalents thereof, are intended to define the scope of the application.

What is claimed is:

1. An electronic file storage system comprising:
a processor;
a memory coupled to the processor, the memory storing program instructions that when executed by the processor, causes the processor to:
read an access log; and
infer access time, modify time, create time, delete time, other metadata from the access log unavailable on the access log, wherein access time, modify time, create time, delete time and other metadata is inferred from a timestamp of an object recorded on the access log.

2. The electronic file storage system of claim 1, wherein the memory storing program instructions that when executed by the processor, causes the processor to:
infer metadata for each object from the access log that is unavailable on the object itself, wherein time is inferred from the timestamp of the object record, wherein access time is inferred from logged reads, create time and modify times are inferred from logged writes, and other times are inferred from other logged operations metadata or other data update times.

3. The electronic file storage system of claim 1, wherein the memory storing program instructions that when executed by the processor, causes the processor to:
store the access time, the modify time, the create time, and other metadata created in a separate database of object metadata that can be queried by a separate computer system.

4. The electronic file storage system of claim 1, wherein the memory storing program instructions that when executed by the processor, causes the processor to:
capture the metadata stored by an object store for each object, and record the metadata in a separate database.

5. The electronic file storage system of claim 1, wherein the memory storing program instructions that when executed by the processor, causes the processor to:
recognize a location of the object in the system along with times of access, create, modify, delete, and metadata update determined from the parsing of the access log;
send a direct request for object metadata from an object store of a newly parsed object; and
record the metadata determined from parsing the access log along with the metadata captured from the object store for each object.

6. The electronic file storage system of claim 5, wherein the memory storing program instructions that when executed by the processor, causes the processor to:
record the metadata determined from parsing the access log along with the metadata captured from the object store for each object in a separate database.

7. The electronic file storage system of claim 1, wherein the memory storing program instructions that when executed by the processor, causes the processor to:
capture a series of access, create, modify, and delete times for the object to store the history of the object in a separate database.

8. The electronic file storage system of claim 1, wherein the memory storing program instructions that when executed by the processor, causes the processor to:
determine a probability of the object being accessed or modified in a future time based on a series of access and modify times of the objects; and
store the probability of the object in a separate database.

9. The electronic file storage system of claim 8, wherein the memory storing program instructions that when executed by the processor, causes the processor to:
determine the probability of the object being accessed or modified using recency of access and historical pattern of access.

10. The electronic file storage system of claim 1, wherein the memory storing program instructions that when executed by the processor, causes the processor to:
label the object as one of a “hot” object or a “cold” object.

11. The electronic file storage system of claim 8, wherein the memory storing program instructions that when executed by the processor, causes the processor to:
label the object as one of a “hot” object or a “cold” object;
label the object as the a “hot” object when the object has been accessed recently within a predetermined timeframe, has a probability of future access above a predetermined threshold level or a combination thereof; and
label the object as the a “cold” object when the object has not been accessed within a predetermined timeframe, has a probability of future access below predetermined number or a combination thereof.

12. The electronic file storage system of claim 10, wherein the memory storing program instructions that when executed by the processor, causes the processor to:
storing the “hot” object in higher performing storage tiers; and
storing the “cold” object in lower performing storage tiers.

13. An electronic file storage system comprising:
a processor;
a memory coupled to the processor, the memory storing program instructions that when executed by the processor, causes the processor to:
parse an access log;
infer access time, modify time, create time, delete time, other metadata from the access log unavailable on the access log, wherein access time, modify time, create time, delete time and other metadata is inferred from a timestamp of an object recorded on the access log, wherein time is inferred from the timestamp of the object record, wherein access time is inferred from logged reads, create time and modify times are inferred from logged writes, and other times are inferred from other logged operations metadata or other data update times;
capture a series of access, create, modify, and delete times for the object to store a history of the object;
determine the probability of the object being accessed or modified using recency of access and historical pattern of access; and
label the object as one of a “hot” object or a “cold” object based on the probability.

14. The electronic file storage system of claim 13, wherein the memory storing program instructions that when executed by the processor, causes the processor to:
store the access time, the modify time, the create time, and other metadata created in a separate database of object metadata that can be queried by a separate computer system.

15. The electronic file storage system of claim 13, wherein the memory storing program instructions that when executed by the processor, causes the processor to:
capture the metadata stored by an object store for each object, and record the metadata in a separate database.

16. The electronic file storage system of claim 13, wherein the memory storing program instructions that when executed by the processor, causes the processor to:
recognize a location of the object in the system along with times of access, create, modify, delete, and metadata update determined from the parsing of the access log;
send a direct request for object metadata from an object store of a newly parsed object; and
record the metadata determined from parsing the access log along with the metadata captured from the object store for each object.

17. The electronic file storage system of claim 13, wherein the memory storing program instructions that when executed by the processor, causes the processor to:
record the metadata determined from parsing the access log along with the metadata captured from the object store for each object in a separate database.

18. The electronic file storage system of claim 13, wherein the memory storing program instructions that when executed by the processor, causes the processor to:
label the object as one of a “hot” object or a “cold” object;
label the object as the a “hot” object when the object has been accessed recently within a predetermined timeframe, has a probability of future access above a predetermined threshold level or a combination thereof; and
label the object as the a “cold” object when the object has not been accessed within a predetermined timeframe, has a probability of future access below predetermined number or a combination thereof.

19. The electronic file storage system of claim 13, wherein the memory storing program instructions that when executed by the processor, causes the processor to:
storing the “hot” object in higher performing storage tiers; and
storing the “cold” object in lower performing storage tiers.
